(19) United States
(12) Patent Application Publication
(10) Pub. No.: US 2026/0104900 A1
(43) Pub. Date: Apr. 16, 2026

(54) METHOD AND A USER INTERFACE FOR CONFIGURING AN ELECTRIC DEVICE

(71) Applicant: Danfoss Power Electronics A/S, Grästen (DK)

(72) Inventors: Klaus Lüking, Husum (DE); Nina Wetcke, Sønderborg (DK)

(21) Appl. No.: 19/357,440

(22) Filed: Oct. 14, 2025

(30) Foreign Application Priority Data
Oct. 16, 2024 (DE) 102024130020.5

(51) Int. Cl. G06F 9/445

(52) U.S. Cl. CPC G06F 9/44505

(57) ABSTRACT

A user interface for configuring an electric device (301) includes a memory system (304) storing wizard data (307) specifying a wizard defining a path through items of configuration data (309) of the electric device. The user interface includes a data processing system (305) for executing the wizard and controlling, during executing the wizard, a display (302) to present the wizard and controlling an input interface (303) to enable a user to supply the configuration data. The wizard is hierarchical and modular, and the user is enabled, during execution of a higher-level module, to configure the wizard via the input interface by defining which lower-level modules of the wizard the user will be guided through in the execution of the wizard. Thus, the wizard is a flexible guide, allowing the user to define what to be guided through, and the wizard can be adapted to various maintenance situations.

### CROSS-REFERENCE TO RELATED APPLICATIONS

This application claims foreign priority benefits under 35 U.S.C. § 119 from German Patent Application No. DE102024130020.5 filed Oct. 16, 2024, the content of which is hereby incorporated by reference in its entirety.

### TECHNICAL FIELD

The invention relates generally to configuring electric devices such as frequency converters. More particularly, the invention relates to a method and to a user interface for configuring an electric device e.g. a frequency converter. Furthermore, the invention relates to a computer program for implementing a user interface by loading the computer program into a programmable device.

### BACKGROUND

Even with a dedicated application-specific software, many electric devices such as frequency converters are extremely flexible and can be used in a wide range of different applications, resulting in a large number of configuration parameters. Sometimes, the number of configuration parameters can be even more than 2000. However, for a specific application, usually only a small proportion of the configuration parameters need to be accessed. As a corollary, in some cases, it can be challenging to a user to identify, from among all configuration parameters, those of the configuration parameters which are relevant to the application under consideration. Thus, for example, setting-up a frequency converter can be a time-consuming task that requires a high level of skills.

To ease a configuration task especially in a commissioning phase, user interfaces of many electric devices provide step-by-step setup wizards. These step-by-step setup wizards help a user to walk through relevant parameters related to an application under consideration. Nevertheless, these step-by-step setup wizards may still be perceived as too comprehensive, time consuming, and cumbersome for different configuration needs. Furthermore, typical setup wizards do not allow direct and fast access to specific features and function groups inside the wizard.

Exemplifying user interfaces which provide setup wizards for feeding data to electric devices are described for example in publications U.S. Pat. No. 7,531,973 and US20230376330. The known user interfaces do not however address the above-described challenges related to the diverse range of situations in which configuration data needs to be entered into an electric device.

### SUMMARY

The following presents a simplified summary to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments.

In accordance with the invention, there is provided a new method for configuring an electric device that can be for example a power electronic converter such as for example a frequency converter, an active front end “AFE” alternating voltage-direct voltage “AC-DC” converter, or a direct voltage-alternating voltage DC-AC inverter “INU”.

The method according to the invention comprises:
storing, in a memory system, wizard data that specifies a wizard which defines a path through items of configuration data of the electric device and is operable to receive the configuration data for the electric device,
executing the wizard with a data processing system,
controlling, with the data processing system and during execution of the wizard, a display to present the wizard to a user,
controlling, with the data processing system and during the execution of the wizard, an input interface to enable the user to supply the configuration data, and
setting a configuration of the electric device in accordance with the configuration data received from the input interface, wherein the wizard is hierarchical and modular so that modules of the wizard are operable to receive module-specific parts of the configuration data, and the user is enabled, during execution of a first one of the modules of the wizard, to configure the wizard via the input interface by defining which one or ones of second ones of the modules of the wizard which are sub-modules of the first one of the modules of the wizard the user will be guided through in the execution of the wizard.

As the user is enabled to define the modules of the wizard which the user will be guided through, the wizard is a flexible guide that can be adapted to various maintenance, service, and other situations where there is a need to modify and/or check the configuration data. For example, in a maintenance situation there is typically no need to walk through a so long and comprehensive path through items of the configuration data like in a commissioning phase when a first-time setup is done. Advantageously, the hierarchical and modular wizard is designed to allow a direct access, or at least a short-path access, to individual parts, e.g. parameters and/or functional groups, related to different modules and/or to allow their re-use for example in a case of triggered actions, e.g. in an over-current situation requiring re-setting and/or acknowledging a part of the configuration data. Therefore, the above-mentioned wizard is not only for a first-time setup, i.e. commissioning, but the wizard can also be adapted for later service and/or maintenance situations around specific topics. This provides the following advantages:
better usability,
a possibility to tailor the wizard for specific needs so that the wizard covers relevant content only,
users save time during e.g. maintenance actions when using a tailored wizard,
saving money and time within training since tailored wizards can be easier to use and learn,
reducing an amount of guidance needed by users for e.g. maintenance actions since tailored wizards can be easier to use and learn, and
minimizing faults caused by e.g. entering configuration data into irrelevant input fields or wrong configuration data into correct input fields.

In this document, the wording “configuration data of an electric device” is to be understood in a broad sense so that the configuration data is not only data related directly to the electric device, e.g. a frequency converter, such as a current limit of the electric device, but the configuration data may also comprise application-specific data related to an application a part of which the electric device is. For example, in conjunction with a pump drive, the application-specific configuration data may comprise e.g. an upper limit of a rotational speed of a pump. The upper limit is dependent on the pump and not on the electric device, e.g. a frequency converter, but nevertheless a value of this upper limit can be deemed to belong to the configuration data of the electric device because the value of this upper limit is supplied to the electric device.

Various embodiments of the invention can be computer implemented invention “CII” embodiments. Therefore, in accordance with the invention, there is also provided a new computer program for implementing a user interface. The computer program according to the invention together with wizard data of the kind described above can be used for programming an electric device that has a programmable central processing unit “CPU” and/or another programmable data processing system to be capable of running the above-described method according to the invention. In other words, the electric device can be programmed to comprise a user interface according to the invention. The computer program can be for example in a form of a signal so that the computer program can be downloaded from a server via a data transfer network into a programmable electric device, e.g. a CPU of a power electronic converter. For another example, the computer program can be in the form of a non-volatile computer readable medium, e.g. an electrically erasable read-only memory “EEPROM” or a universal serial bus “USB” memory, encoded with the computer program and connectable to a programmable electric device, e.g. a CPU of a power electronic converter.

The computer program according to the invention comprises computer executable instructions for controlling a programmable data processing system to:
retrieve, from a memory system, wizard data that specifies a wizard defining a path through items of configuration data of an electric device to be configured and being operable to receive the configuration data for the electric device,
execute the wizard,
control, during execution of the wizard, a display to present the wizard to a user,
control, during the execution of the wizard, an input interface to enable the user to supply the configuration data, and
set a configuration of the electric device in accordance with the configuration data received from the input interface, wherein the wizard is hierarchical and modular so that modules of the wizard are operable to receive module-specific parts of the configuration data, and the computer program comprises computer executable instructions for controlling the programmable data processing system to enable the user, during execution of a first one of the modules of the wizard, to configure the wizard via the input interface by defining which one or ones of second ones of the modules of the wizard which are sub-modules of the first one of the modules of the wizard the user will be guided through in the execution of the wizard.

In accordance with the invention, there is also provided a new computer program product. The computer program product comprises a non-volatile computer readable medium, e.g. an EEPROM” or a USB memory, encoded with a computer program according to the invention.

In accordance with the invention, there is also provided a new user interface for configuring an electric device that can be for example a power electronic converter such as for example a frequency converter, an active front end “AFE” alternating voltage-direct voltage “AC-DC” converter, or a direct voltage-alternating voltage DC-AC inverter “INU”. The user interface can be for example a part of the electric device to be configured, or the user interface can be a part of an external device, e.g. a laptop or a smartphone, connectable to the electric device to be configured, or a part of the user interface can be a part of the electric device to be configured and another part of the of the user interface can be a part of an external device. Thus, the invention is not limited to any specific ways to implement the user interface.

The user interface according to the invention comprises:
a display and an input interface,
a memory system configured to store wizard data specifying a wizard defining a path through items of configuration data of the electric device and being operable to receive the configuration data for the electric device, and a data processing system configured to:
execute the wizard,
control, during execution of the wizard, the display to present the wizard to a user,
control, during the execution of the wizard, the input interface to enable the user to supply the configuration data, an
set a configuration of the electric device in accordance with the configuration data received from the input interface, wherein the wizard is hierarchical and modular so that modules of the wizard are operable to receive module-specific parts of the configuration data, and the data processing system is configured to enable the user, during execution of a first one of the modules of the wizard, to configure the wizard via the input interface by defining which one or ones of second ones of the modules of the wizard which are sub-modules of the first one of the modules of the wizard the user will be guided through in the execution of the wizard.

In accordance with the invention, there is also provided a new power electronic converter that can be for example a frequency converter, an active front end “AFE” alternating voltage-direct voltage “AC-DC” converter, or a direct voltage-alternating voltage DC-AC inverter “INU”. The power electronic converter comprises:
a power electronic main circuit configured to convert one or more input voltages to one or more output voltages,
control equipment configured to control the power electronic main circuit, and
configuration equipment for configuring the power electronic converter, the configuration equipment comprising a user interface according to the invention.

The configuration equipment can be implemented at least partly with same hardware as the above-mentioned control equipment, or the configuration equipment can be implemented with separate hardware with respect to the control equipment.

Exemplifying and non-limiting embodiments are described in accompanied dependent claims.

Exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of un-recited features.

The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE DRAWINGS

Exemplifying and non-limiting embodiments and their advantages are explained in greater detail below in the sense of examples and with reference to the accompanying drawings, in which:

FIG. 1 shows a flowchart of a method according to an exemplifying and non-limiting embodiment for configuring an electric device,

FIG. 2 illustrates an exemplifying wizard accomplished with a method according to an exemplifying and non-limiting embodiment, and

FIG. 3 illustrates a user interface according to an exemplifying and non-limiting embodiment for configuring an electric device.

### DETAILED DESCRIPTION

The specific examples provided in the description below should not be construed as limiting the scope and/or the applicability of the invention. Lists and groups of examples provided in the description are not exhaustive unless otherwise explicitly stated.

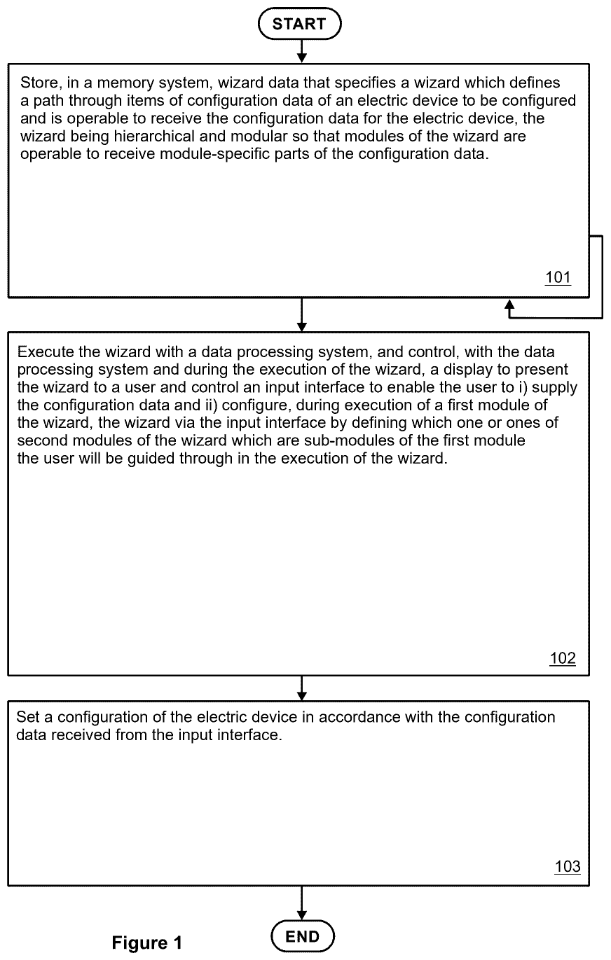

FIG. 1 shows a flowchart of a method according to an exemplifying and non-limiting embodiment for configuring an electric device that can be for example a power electronic converter such as for example a frequency converter, an active front end “AFE” alternating voltage-direct voltage “AC-DC” converter, or a direct voltage-alternating voltage DC-AC inverter “INU”. The method comprises the following actions:

action 101: storing, in a memory system, wizard data that specifies a wizard which defines a path through items of configuration data of the electric device and is operable to receive the configuration data for the electric device, the wizard being hierarchical and modular so that modules of the wizard are operable to receive module-specific parts of the configuration data,
action 102: executing the wizard with a data processing system, and controlling, with the data processing system and during the execution of the wizard, a display to present the wizard to a user and controlling an input interface to enable the user to i) supply the configuration data and ii) configure the wizard, during execution of a first one of the modules of the wizard, by defining which one or ones of second ones of the modules of the wizard which are sub-modules of the first one of the modules of the wizard the user will be guided through in the execution of the wizard, and
action 102: setting a configuration of the electric device in accordance with the configuration data received from the input interface.

The number of the hierarchy levels in the hierarchical and modular wizard can be two or more. In the above-described method, the number of the hierarchy levels is at least two.

In a method according to an exemplifying and non-limiting embodiment, the number of the hierarchy levels is at least three. In this exemplifying embodiment, the user is enabled, during execution of at least one of the above-mentioned second ones of the modules of the wizard, to configure the wizard via the input interface by defining which one or ones of third ones of the modules of the wizard which are sub-modules of the one of the second ones of the modules of the wizard the user will be guided through in the execution of the wizard.

In a method according to an exemplifying and non-limiting embodiment, the number of the hierarchy levels is at least four. In this exemplifying embodiment, the user is enabled, during execution of at least one of the above-mentioned third ones of the modules of the wizard, to configure the wizard via the input interface by defining which one or ones of fourth ones of the modules of the wizard which are sub-modules of the one of the third ones of the modules of the wizard the user will be guided through in the execution of the wizard.

As evident in the light of the above-mentioned exemplifying embodiments, the number of the hierarchy levels in the hierarchical and modular wizard can be any number greater than or equal to two.

The above-mentioned data processing system can be for example a central processing unit “CPU” or another processing unit of the electric device to be configured, e.g. a frequency converter. Alternatively, the data processing system can be an external device, e.g. a processor of a laptop or a smartphone, communicatively connected to the CPU or to the other processing unit of the electric device to be configured. Correspondingly, the display and/or the input interface can be an element or elements of the electric device to be configured e.g. a frequency converter or, alternatively, the display and/or the input interface can belong to an external device, e.g. a laptop or a smartphone, communicatively connected to the CPU or to the other processing unit of the electric device to be configured.

In a method according to an exemplifying and non-limiting embodiment, the above-mentioned input interface comprises a keyboard having arrow and selection buttons for controlling progress of the wizard and alphanumeric buttons enabling the user to feed an item of the configuration data when an input field for feeding the item of the configuration data has been activated.

In a method according to an exemplifying and non-limiting embodiment, the above-mentioned display comprises a touch screen acting as the input interface, and the method comprises controlling the display to present virtual arrow and selection buttons for controlling progress of the wizard and virtual alphanumeric buttons enabling the user to feed an item of the configuration data when an input field for feeding the item of the configuration data has been activated.

A method according to an exemplifying and non-limiting embodiment comprises recording, into the memory system, selection data expressing which one or ones of the modules of the wizard are to be executed, and to retrieve the selection data from the memory system when the wizard is started next time. Thus, the wizard can be adapted to various maintenance, service, and other situations in which there is a need to modify and/or check the configuration data. Therefore, the wizard does not need to support only a first-time setup, i.e. a commissioning, but the wizard can also be adapted to guide in later service and/or maintenance situations around specific topics.

In a method according to an exemplifying and non-limiting embodiment, the configuration data comprises first configuration parameters, e.g. a current limit, a temperature limit, etc., related to the electric device to be configured and second configuration parameters related to an application, e.g. a pump drive, a blower drive, etc., a part of which the electric device is.

In a method according to an exemplifying and non-limiting embodiment, the configuration data comprises one or more of the following: speed control parameters, torque control parameters, power control parameters, current and voltage limit parameters, power limit parameters, closed loop control mode parameters, open loop control mode parameters, speed ramping parameters, and/or application, e.g. a pump drive, specific parameters, etc.

A computer program according to an exemplifying and non-limiting embodiment for implementing a user interface comprises computer executable instructions for controlling a programmable data processing system to carry out actions related to a method according to any of the above-described exemplifying and non-limiting embodiments.

A computer program according to an exemplifying and non-limiting embodiment comprises software modules for implementing a user interface. The software modules comprise computer executable instructions for controlling a programmable data processing system to:
retrieve, from a memory system, wizard data that specifies a wizard which defines a path through items of configuration data of an electric device to be configured and is operable to receive the configuration data for the electric device, the wizard being hierarchical and modular so that modules of the wizard are operable to receive module-specific parts of the configuration data
execute the wizard,
control, during execution of the wizard, a display to present the wizard to a user and control an input interface to enable the user to i) supply the configuration data and ii) configure the wizard, during execution of a first one of the modules of the wizard, by defining which one or ones of second ones of the modules of the wizard which are sub-modules of the first one of the modules of the wizard the user will be guided through in the execution of the wizard, and
set a configuration of the electric device in accordance with the configuration data received from the input interface.

The software modules can be for example subroutines or functions implemented with programming tools suitable for the programmable data processing system.

In a computer program according to an exemplifying and non-limiting embodiment, the software modules comprise computer executable instructions for controlling the programmable data processing system to enable the user, during execution of at least one of the above-mentioned second ones of the modules of the wizard, to configure the wizard via the input interface by defining which one or ones of third ones of the modules of the wizard which are sub-modules of the one of the second ones of the modules of the wizard the user will be guided through in the execution of the wizard.

In a computer program according to an exemplifying and non-limiting embodiment, the software modules comprise computer executable instructions for controlling the programmable data processing system to enable the user, during execution of at least one of the above-mentioned third ones of the modules of the wizard, to configure the wizard via the input interface by defining which one or ones of fourth ones of the modules of the wizard which are sub-modules of the one of the third ones of the modules of the wizard the user will be guided through in the execution of the wizard.

As evident in the light of the computer programs according to the above-mentioned exemplifying embodiments, the number of the hierarchy levels in the hierarchical and modular wizard can be any number greater than or equal to two.

In a computer program according to an exemplifying and non-limiting embodiment, the software modules comprise computer executable instructions for controlling the programmable data processing system to record, into the memory system, selection data expressing which one or ones of the modules of the wizard are to be executed, and to retrieve the selection data from the memory system when the wizard is started next time.

A computer program product according to an exemplifying and non-limiting embodiment comprises a computer readable medium, e.g. an EEPROM” or a USB memory, encoded with a computer program according to an exemplifying embodiment of the invention.

A signal according to an exemplifying and non-limiting embodiment is encoded to carry information defining a computer program according to an exemplifying embodiment of the invention.

A non-volatile computer readable medium, e.g. an EEPROM” or a USB memory, according to an exemplifying and non-limiting embodiment is encoded with a computer program according to an exemplifying embodiment of the invention.

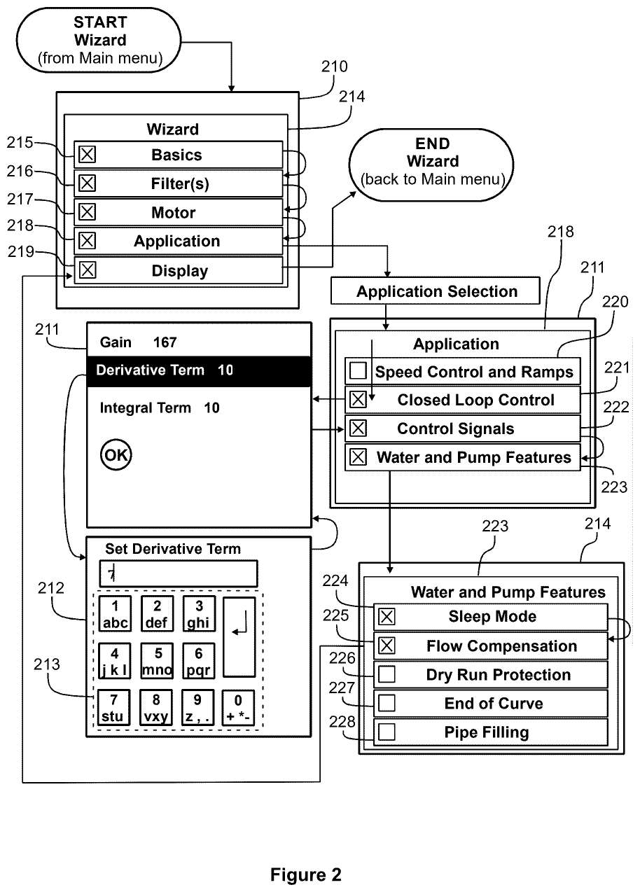

FIG. 2 illustrates an exemplifying hierarchical and modular wizard accomplished with a method according to an exemplifying and non-limiting embodiment. In this exemplifying embodiment, the display comprises a touch screen that acts as the input interface and the data processing system is configured to control the display to present virtual alphanumeric buttons 213 to enable a user to feed configuration data when a corresponding input field has been selected. The wizard data has data portions which define the wizard modules and data portions which define how the wizard modules are connected to each other to constitute the modular and hierarchical wizard.

In the exemplifying situation shown in FIG. 2, a first display view 210 shows a topmost hierarchy level of the wizard. The first display view 210 shows a first wizard module 214 that represents the highest hierarchy level and includes the following second wizard modules 215, 216, 217, 218, and 219 that are sub-modules of the first wizard module 214. Each of the second wizard modules 215-219 is a guided path through configuration parameters and/or other configuration related entities, e.g. functional groups, to obtain configuration data related to the wizard module under consideration. In this exemplifying case, the second wizard modules 215-219 are: “Basics”, “Filter(s)”, “Motor”, “Application”, and “Display”. In this exemplifying case, each of the wizard modules 215-219 has a cross-box that acts as a checkmark with the aid of which a user can select whether the wizard module under consideration is to be executed. In the exemplifying situation shown in FIG. 2, all the above-mentioned wizard modules 215-219 are selected to be executed. These wizard modules 215-219 can be executed starting from a topmost selected one of the wizard modules 215-219, and the order of execution can be downwards in the list of the wizard modules 215-219 shown in the first display view 210. It is also possible that each of the wizard modules 215-219 is accessible e.g. by selecting a desired one of the wizard modules 215-219 on the first display view 210. This makes it possible to access a configuration parameter without a need to walk through a whole guided path to the configuration parameter.

In the exemplifying situation shown in FIG. 2, the wizard module 218 “Application” is under execution. At the beginning of the guided path defined by the wizard module 218 “Application” there is an “Application Selection” query in which a user can define or select the application under consideration. A choice in the “Application Selection” determines which lower-level third wizard modules are available in the wizard module 218 “Application”. In this exemplifying case, the following third wizard modules shown in a second display view 211 are available: “Speed Control and Ramps” 220, “Closed Loop Control” 221, “Control Signals” 222, and “Water and Pumps Features” 223. In this exemplifying case, each of the wizard modules 220-223 has a cross-box that acts as a checkmark with the aid of which a user can select whether the wizard module under consideration is to be executed. In the exemplifying situation shown in FIG. 2, the wizard modules 221-223 have been selected to be executed whereas wizard module 220 “Speed Control and Ramps” will not be executed. In the exemplifying situation shown in FIG. 2, the wizard module 221 “Closed Loop Control” is executed first in the higher-level wizard module 218 “Application”. This leads to a third display view 211 which shows configuration parameters related to the wizard module 221 “Closed Loop Control”. In the exemplifying situation shown in FIG. 2, the configuration parameter “Derivative Term” has been selected leading to a fourth display view 212 presenting the above-mentioned virtual alphanumeric buttons 213 which enable the user to set a value of the configuration parameter “Derivative Term”. After the wizard module 221 “Closed Loop Control” has been executed, the wizard modules 222 “Control signal” and 223 “Water and Pump Features” are executed successively. As shown in FIG. 2, the wizard module “Water and Pump Features” comprises lower-lever fourth wizard modules 224, 225, 226, 227, and 228. In this exemplifying case, the wizard modules 224 “Sleep Mode” and 226 “Flow Compensation” have been selected, with the respective cross-boxes, to be executed. After the execution of the wizard module 225 “Flow Compensation”, the wizard module 218 “Application” has come to its end and the next action is an execution of the wizard module “Display” 219. Thereafter, the wizard has come to its end, and the operation may get back to e.g. a main menu.

The exemplifying hierarchical and modular wizard illustrated in FIG. 2 has four hierarchy levels so that the first wizard module 214 constitute the highest level, the second wizard modules 215-219 belong to the second highest level, the third wizard modules 220-223 belong second lowest level, and the fourth wizard modules 224-228 belong to the lowest level of the hierarchy. As evident, this is a non-limiting example only and the number of the hierarchy levels in a hierarchical and modular wizard according to embodiments of the invention can be any number greater than or equal to two.

The wizard modules may alternatively and individually be accessed and executed, e.g. the wizard module 217 “Motor” may be accessed directly from e.g. an external device such as a laptop, a personal computer “PC”, a smartphone, another computing device, etc.

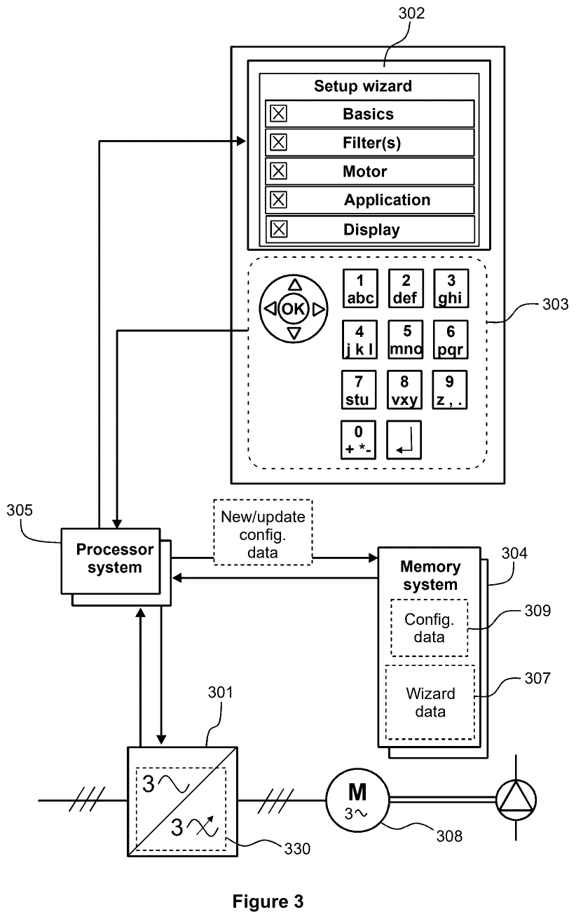

FIG. 3 illustrates a user interface according to an exemplifying and non-limiting embodiment for configuring an electric device 301. In the exemplifying case shown in FIG. 3, the electric device 301 is a frequency converter for converting one or more alternating voltages, e.g. a three-phase grid voltage, to one or more controllable alternating voltages suitable for an electric machine 308, but, as mentioned earlier in this document, this is only one example. In this exemplifying case, the electric device 301 comprises a power electronic main circuit 330 configured to convert the one or more alternating voltages to the one or more controllable alternating voltages, and control equipment configured to control the power electronic main circuit 330.

The user interface for configuring the electric device 301 comprises a display 302 that can be for example a liquid crystal display “LCD”. The display 302 can be a part of a user interface of the electric device 301, e.g. a frequency converter, or the display 302 can be a part of an external device, e.g. a laptop or smartphone, communicatively connected to control and management means of the electric device 301. The user interface comprises an input interface 303 configured to enable a user to provide configuration data 309 for the electric device 301. The input interface 303 can be a part of a user interface of the electric device 301, e.g. a frequency converter, or the input interface 303 can be a part of an external device, e.g. a laptop or smartphone, communicatively connected to the control and management means of the electric device 301. In this exemplifying embodiment, the input interface 103 comprises a keyboard that has arrow and selection buttons for controlling progress of the wizard and alphanumeric buttons for feeding a configuration data item, e.g. a current limit, when an input field for feeding the configuration data item has been activated. The keyboard may have mechanical buttons, or the keyboard can be implemented with a touch screen.

The apparatus comprises a memory system 304 that stores wizard data specifying a wizard that defines a path through items of the configuration data 309 of the electric device and is operable to receive the configuration data 309 for the electric device 301 and/or for an application, e.g. a pump drive, a part of which the electric device 301 is. The wizard is hierarchical and modular so that modules of the wizard are operable to receive module-specific parts of the configuration data 309. The memory system 304 may comprise one or more memory circuits which may comprise e.g. one or more electronically erasable programmable read-only memory “EEPROM” circuits or one or more other suitable memory circuits for storing the wizard data and other data which must not be lost in power off situations. Furthermore, the memory system 304 may comprise one or more random-access memory “RAM” circuits for working memory. The memory system 304 can be a part of the electric device 301, e.g. a frequency converter, or the memory system 304 can be a part of an external device, e.g. a laptop or smartphone, communicatively connected to the control and management means of the electric device 301.

The user interface comprises a data processing system 305 that is communicatively connected to the display 302, to the input interface 303, and to the memory system 304. The data processing system 305 can be a part of the electric device 301, e.g. a central processing unit “CPU” or another processing unit of a frequency converter, or the data processing system 305 can be a part of an external device, e.g. a laptop or smartphone, communicatively connected to the control and management means of the electric device 301. Typically, the user interface for configuring the electric device 301 is a part of the electric device 301, but in FIG. 3 the user interface is depicted with separate functional elements for the sake of illustration.

The data processing system 305 is configured to execute the wizard and to control, during the execution of the wizard, the display 302 to present the wizard to a user and to control the input interface 303 to enable the user to i) supply the configuration data 309 and ii) configure, during execution of a first one of the modules of the wizard, the wizard by defining which one or ones of second ones of the modules of the wizard which are sub-modules of the first one of the modules of the wizard the user will be guided through in the execution of the wizard. Furthermore, the data processing system 305 can be configured to enable the user, during execution of at least one of the above-mentioned second ones of the modules of the wizard, to configure the wizard via the input interface by defining which one or ones of third ones of the modules of the wizard which are sub-modules of the one of the second ones of the modules of the wizard the user will be guided through in the execution of the wizard. Yet furthermore, the data processing system 305 can be configured to enable the user, during execution of at least one of the above-mentioned third ones of the modules of the wizard, to configure the wizard via the input interface by defining which one or ones of fourth ones of the modules of the wizard which are sub-modules of the one of the thirds ones of the modules of the wizard the user will be guided through in the execution of the wizard, and so on. Thus, the wizard is a flexible guide, allowing the user to define what to be guided through.

In a user interface according to an exemplifying and non-limiting embodiment, the data processing system 305 is configured to record, into the memory system 304, selection data expressing which one or ones of the modules of the wizard are to be executed, and to retrieve the selection data from the memory system 304 when the wizard is started next time. Thus, the wizard can be adapted to various maintenance, service, and other situations in which there is a need to modify and/or check the configuration data 309. Therefore, the wizard is not only for a first-time setup, i.e. commissioning, but the wizard can also be adapted for later service and/or maintenance situations around specific topics.

The configuration data 309 may comprise for example first configuration parameters related to the electric device 301 and second configuration parameters related to an application a part of which the electric device 301 is. The configuration parameters may comprise for example speed control parameters, torque control parameters, power control parameters, current and voltage limit parameters, power limit parameters, closed loop control mode parameters, open loop control mode parameters, speed ramping parameters, and/or application, e.g. a pump drive, specific parameters, etc. Configuration parameters related to some electric devices and/or applications can be interrelated so that first one or ones of the configuration parameters determine values or value ranges for second one or ones of the configuration parameters. In an apparatus according to an exemplifying and non-limiting embodiment, the data processing system 305 is configured to adjust, as a background operation, the second one or ones of the configuration parameters when the first one or ones of the configuration parameters are obtained via the input interface 303 while executing the wizard.

In an apparatus according to an exemplifying and non-limiting embodiment, the input interface 303 comprises a keyboard having arrow and selection buttons for controlling progress of the wizard and alphanumeric buttons enabling the user to feed an item of the configuration data 309 when an input field for feeding the item of the configuration data has been activated.

In an apparatus according to an exemplifying and non-limiting embodiment, the display 302 comprises a touch screen for acting as the input interface 303, and the data processing system 305 is configured to control the display to present virtual arrow and selection buttons for controlling progress of the wizard and virtual alphanumeric buttons enabling the user to feed an item of the configuration data 309 when an input field for feeding the item of the configuration data has been activated.

The implementation of the data processing system 305 can be based on one or more analogue circuits, one or more digital processing circuits, or a combination thereof. Each digital processing circuit can be a programmable processor circuit provided with appropriate software, a dedicated hardware processor such as for example an application specific integrated circuit “ASIC”, or a configurable hardware processor such as for example a field programmable gate array “FPGA”. Furthermore, the data processing system 305 may comprise working memory that can be implemented with one or more random-access memory “RAM” circuits.

The specific examples provided in the description given above should not be construed as limiting the scope and/or the applicability of the invention. Lists and groups of examples provided in the description given above are not exhaustive unless otherwise explicitly stated.

What is claimed is:

1. A method for configuring an electric device, the method comprising:
storing, in a memory system, wizard data that specifies a wizard which defines a path through items of configuration data of the electric device and is operable to receive the configuration data for the electric device,
executing the wizard with a data processing system,
controlling, with the data processing system and during execution of the wizard, a display to present the wizard to a user,
controlling, with the data processing system and during the execution of the wizard, an input interface to enable the user to supply the configuration data, and
setting a configuration of the electric device in accordance with the configuration data received from the input interface,
wherein the wizard is hierarchical and modular so that modules of the wizard are operable to receive module-specific parts of the configuration data, and the user is enabled, during execution of a first one of the modules of the wizard, to configure the wizard via the input interface by defining which one or ones of second ones of the modules of the wizard which are sub-modules of the first one of the modules of the wizard the user will be guided through in the execution of the wizard.

2. The method according to claim 1, wherein the user is enabled, during execution of at least one of the second ones of the modules of the wizard, to configure the wizard via the input interface by defining which one or ones of third ones of the modules of the wizard which are sub-modules of the one of the second ones of the modules of the wizard the user will be guided through in the execution of the wizard.

3. The method according to claim 2, wherein the user is enabled, during execution of at least one of the third ones of the modules of the wizard, to configure the wizard via the input interface by defining which one or ones of fourth ones of the modules of the wizard which are sub-modules of the one of the third ones of the modules of the wizard the user will be guided through in the execution of the wizard.

4. The method according to claim 1, wherein the input interface comprises a keyboard having arrow and selection buttons for controlling progress of the wizard and alphanumeric buttons enabling the user to feed an item of the configuration data when an input field for feeding the item of the configuration data has been activated.

5. The method according to claim 1, wherein the display comprises a touch screen acting as the input interface, and the method comprises controlling the display to present virtual arrow and selection buttons for controlling progress of the wizard and virtual alphanumeric buttons enabling the user to feed an item of the configuration data when an input field for feeding the item of the configuration data has been activated.

6. The method according to claim 1, wherein the configuration data comprises first configuration parameters related to the electric device and second configuration parameters related to an application a part of which the electric device is.

7. The method according to claim 1, wherein the configuration data comprises one or more of following: speed control parameters, torque control parameters, power control parameters, current and voltage limit parameters, power limit parameters, closed loop control mode parameters, open loop control mode parameters, speed ramping parameters, and application specific parameters.

8. The method according to claim 1, wherein the electric device is a frequency converter.

9. A computer program for implementing a user interface, the computer program comprising computer executable instructions for controlling a programmable data processing system to:
retrieve, from a memory system, wizard data that specifies a wizard defining a path through items of configuration data of an electric device to be configured and being operable to receive the configuration data for the electric device,
execute the wizard,
control, during execution of the wizard, a display to present the wizard to a user,
control, during the execution of the wizard, an input interface to enable the user to supply the configuration data, and
set a configuration of the electric device in accordance with the configuration data received from the input interface,
wherein the wizard is hierarchical and modular so that modules of the wizard are operable to receive module-specific parts of the configuration data, and the computer program comprises computer executable instructions for controlling the programmable data processing system to enable the user, during execution of a first one of the modules of the wizard, to configure the wizard via the input interface by defining which one or ones of second ones of the modules of the wizard which are sub-modules of the first one of the modules of the wizard the user will be guided through in the execution of the wizard.

10. The computer program according to claim 9, wherein the computer program comprises computer executable instructions for controlling the programmable data processing system to enable the user, during execution of at least one of the second ones of the modules of the wizard, to configure the wizard via the input interface by defining which one or ones of third ones of the modules of the wizard which are sub-modules of the one of the second ones of the modules of the wizard the user will be guided through in the execution of the wizard.

11. The computer program according to claim 10, wherein the computer program comprises computer executable instructions for controlling the programmable data processing system to enable the user, during execution of at least one of the third ones of the modules of the wizard, to configure the wizard via the input interface by defining which one or ones of fourth ones of the modules of the wizard which are sub-modules of the one of the third ones of the modules of the wizard the user will be guided through in the execution of the wizard.

12. A non-volatile computer readable medium encoded with a computer program according to claim 9.

13. A user interface for configuring an electric device, the user interface comprising:
a display and an input interface,
a memory system configured to store wizard specifying a wizard defining a path through items of configuration data of an electric device and being operable to receive the configuration data for the electric device, and
a data processing system configured to:
execute the wizard,
control, during execution of the wizard, the display to present the wizard to a user,
control, during the execution of the wizard, the input interface to enable the user to supply the configuration data, and
set a configuration of the electric device in accordance with the configuration data received from the input interface,
wherein the wizard is hierarchical and modular so that modules of the wizard are operable to receive module-specific parts of the configuration data, and the data processing system is configured to enable the user, during execution of a first one of the modules of the wizard, to configure the wizard via the input interface by defining which one or ones of second ones of the modules of the wizard which are sub-modules of the first one of the modules of the wizard the user will be guided through in the execution of the wizard.

14. The user interface according to claim 13, wherein the data processing system is configured to enable the user, during execution of at least one of the second ones of the modules of the wizard, to configure the wizard via the input interface by defining which one or ones of third ones of the modules of the wizard which are sub-modules of the one of the second ones of the modules of the wizard the user will be guided through in the execution of the wizard.

15. The user interface according to claim 14, wherein the data processing system is configured to enable the user, during execution of at least one of the third ones of the modules of the wizard, to configure the wizard via the input interface by defining which one or ones of fourth ones of the modules of the wizard which are sub-modules of the one of the third ones of the modules of the wizard the user will be guided through in the execution of the wizard.

16. The user interface according to claim 13, wherein the input interface comprises a keyboard having arrow and selection buttons for controlling progress of the wizard and alphanumeric buttons enabling the user to feed an item of the configuration data when an input field for feeding the item of the configuration data has been activated.

17. The user interface according to claim 13, wherein the display comprises a touch screen for acting as the input interface, and the data processing system is configured to control the display to present virtual arrow and selection buttons for controlling progress of the wizard and virtual alphanumeric buttons to enable the user to feed an item of the configuration data when an input field for feeding the item of the configuration data has been activated.

18. A power electronic converter comprising:
a power electronic main circuit configured to convert one or more input voltages to one or more output voltages,
control equipment configured to control the power electronic main circuit, and
configuration equipment for configuring the power electronic converter, the configuration equipment comprising a user interface according to claim 13.

19. The power electronic converter according to claim 18, wherein the power electronic converter is a frequency converter.
